(19) United States
(12) Patent Application Publication
(10) Pub. No.: US 2009/0291758 A1
(43) Pub. Date: Nov. 26, 2009

(54) METHOD AND APPARATUS FOR TELEVISING A CARD GAME

(75) Inventors: Kevan Moretti, Wiltshire (GB); Nick Bryan, Wiltshire (GB); Alan Edward Green, Cambridge (GB); David John Stocks, Hertfordshire (GB)

Correspondence Address: PARK, VAUGHAN & FLEMING LLP, 2820 FIFTH STREET, DAVIS, CA, 95618-7759, US

(73) Assignee: IKNOWLEDGE LTD., Surrey (UK)

(21) Appl. No.: 12/302,078

(22) PCT Filed: May 30, 2006
(86) PCT No.: PCT/GB06/01953

§ 371 Date: Nov. 24, 2008

(30) Foreign Application Priority Data
May 30, 2006 (GB) PCT/GB2006/001953

(51) Int. Cl. A63F 13/00

(52) U.S. Cl. 463/31

(57) ABSTRACT

One embodiment of the invention provides a method of televising a card game. Each playing card in the card game has a value. The method includes providing the back surface of each playing card with a marking that is substantially invisible to the naked eye. The marking indicates the value of the playing card. An infrared detector is used to access the marking to identify the value of a playing card involved in the card game. Visual information indicative of the identified value of the playing card is generated and included in a broadcast of the card game.

### FIELD OF THE INVENTION

The present invention relates to a method and apparatus for televising a card game such as poker.

### BACKGROUND OF THE INVENTION

There has been significant growth in the last few years in the popularity of card and casino games such as poker. A major aspect of this popularity has been a large increase in the number of people participating in on-line games over the Internet. Another aspect is wider television coverage of players participating in such games, often for very substantial stakes. It will also be appreciated that there are very many television channels now available, whether via cable, satellite, or terrestrial broadcast (in analog or digital form), as well as webcast channels supplied over the Internet. These channels are all looking for content to fill their schedules, and casino games provide an opportunity to offer interesting and exciting programming at reasonable production costs.

Most card games involve players receiving at least some of their cards face-down. The value of such a face-down card is known to the recipient of the card (who can look at the card), but not to any of the other participants in the game. However, broadcasters (including webcasters) generally want to be able to identify which cards a particular player is holding at any given time. This information can then be used to drive commentaries, for example in relation to the tactics adopted by a given player. Information about cards received face-down is also of great interest to viewers who are following the game, and helps them to appreciate the differing styles of players in the game.

Current programmes have generally used high-definition cameras to ascertain the values of face-down cards dealt to the players. In many cases, these cameras are positioned looking upwards from underneath a glass table top, so as to be able to see cards dealt face-down onto the table top. Alternatively (or additionally) cameras may be placed adjacent players, so as to acquire the same view of the cards as a player. In other words, when a player raises cards dealt face-down to review his or her hand, the faces of the cards are likewise visible to the camera.

Unfortunately, neither of these approaches is completely unsatisfactory. For example, a glass table-top provides a rather unnatural environment for a casino game, where cards are normally dealt onto a (non-reflective) baize surface. In addition, cards may lie on top of another, so that a camera only has a clear view of the bottom card, but not of the other cards above (behind) this bottom card. The faces of the cards might also be obscured, at least in part, by a player's fingers or hands. (The psychology of games such as poker is strongly against showing your hand to anyone, even television sponsors). It will also be appreciated that the use of multiple cameras can become quite complicated and expensive, especially if the number of players involved is relatively large.

Once the cards dealt to the players have been identified, this information is normally recorded into a computer system. The stored information about the cards dealt to the various players can then be used for a variety of purposes, such as to inform commentators. However, even after a camera image of a player's hand has been acquired, this still does not provide the card information directly for storage into a computer system. Rather, it is necessary to process an image obtained from the camera to deduce the identity of the card or cards shown in the image. Such image processing may be difficult in a casino environment, if the cards are poorly lit or held at various angles. Consequently, most casino programming relies upon a human operator to monitor the camera images in order to identify the various cards held by the players. The human operator is then responsible for entering the identity of the cards into a computer system such described above. However, such human operation may be prone to error, and in addition this approach becomes significantly harder as more players are involved in the game (say rising to 6-10 participants), in which case the operator has to cope with a large number of hands in a short period of time.

### SUMMARY OF THE INVENTION

Accordingly, one embodiment of the invention provides a method of televising a card game in which each playing card in the card game has a value (for example, for conventional playing cards, king of hearts, ten of diamonds, etc.). The method includes providing the back surface of each playing card with a marking that is substantially invisible to the naked eye. The marking indicates the value of the playing card. A detector of non-visible radiation is used to access the markings to identify the values of the playing cards involved in the card game. Visual information indicative of the identified values of the playing cards is generated for inclusion in a television broadcast of the card game.

Such an approach avoids the need for a glass table-top surface for playing the card game on, and so provides for a more natural and hence less disruptive environment for the televised card game. Note that such television broadcast may be supplied over any appropriate television network (e.g. terrestrial, satellite, cable, digital, closed-circuit), over a computer network such as the internet (whether via live streaming, webcast, on-demand download, etc.), over a mobile telephone network to mobile handsets (cellphones) or other portable devices that support viewing, or over any other suitable distribution medium. The visual information may comprise text, image, graphics, animation, etc. (or some combination of these), and may, for example, be superimposed or interspersed with a live image of the card game as appropriate.

In one embodiment, the detector sensitive to non-visible radiation is an infrared detector. However, other embodiments may use a detector for different non-visible wavelengths, such as ultra-violet radiation.

In one embodiment, the marking is made with an infrared absorbing dye. This marking can then be accessed by illuminating the marking with infrared radiation, and using an infrared detector to discern the pattern of the dye on the back surface of the card. Depending upon the particular configuration adopted, the illumination may be provided by a dedicated infrared lamp (e.g. an infrared LED), or alternatively conventional light sources may provide enough illumination in the infrared to allow the markings to be detected.

In one particular embodiment, the absorption peak of the infrared absorbing dye is in the range 840-920 nm. If the absorption peak is too close to the visible (i.e. too short a wavelength), there is a tendency for the dye to absorb light at visible wavelengths (and so be visible to the human eye). Alternatively, if the absorption peak is longer, detection (and illumination) becomes more difficult, requiring relatively specialised and expensive equipment. In one particular embodiment, the absorption peak of the infrared absorbing dye is in the range 840-920 nm. An absorption peak in the range 875-905 nm has been found to be particularly convenient for working with readily available equipment yet avoiding visibility of the markings to the human eye.

In another embodiment, the marking is made with an infrared fluorescent dye. Such dye is typically illuminated with visible light (whether ambient or specially provided) and then emits (fluoresces) infrared radiation.

Most high quality cards have a transparent plastic coating for protective purposes. In one particular embodiment, the marking is made with a dye that has penetrated this plastic coating in order to increase the longevity of the marking. This can be achieved by using a solvent such as methyl ethyl ketone for the dye, where the solvent temporarily softens the plastic coating of the playing card to allow the dye to penetrate.

Since many infrared dyes are susceptible to damage by ultraviolet radiation, in one embodiment the playing card is covered with a coating to provide protection (filtering) for the marking against such ultraviolet radiation. Such a coating may be applied to the playing card by an aerosol or via any other suitable mechanism.

In one embodiment, the back surface of the playing card appears substantially red in visible light. This colouring is most likely to reflect incident infrared radiation, and so provides a high contrast for the marking if an infrared absorbing dye is used for the marking. (In effect, the marking then appears dark against a light background).

In one embodiment, the marking comprises a barcode that encodes the value of the playing card. A barcode has the advantage of being directly interpreted by a machine to access the value of the playing card (in contrast for example to an image of the face of a playing card), and has been specifically designed for robust and reliable reading. A further advantage of using a barcode is that even if there is any minimal residual visibility of the marking at visual wavelengths, it is still difficult for a human to decipher the barcode. However, any other appropriate form of marking can be used to identify the card value instead of a barcode if so desired.

In one particular embodiment, the barcode has a minimum feature width of at least 2 mm. Note that having a large feature width generally makes it easier for the bar code to be read (especially if the detector is positioned at some distance so as not to interfere unduly with the players). It will also be appreciated that the feature width can be relatively large because the bar code only needs to encode 52 different states (for a conventional pack of playing cards, plus additional states for any jokers if included). However, in other embodiments a smaller feature width (e.g. of 1 mm) might be supported, depending on the particular equipment adopted.

In one embodiment, where the marking comprises a barcode, the detector comprises an bar code scanner (e.g. an infrared barcode spanner if the markings are infrared). Such a device may include an infrared laser or other appropriate optical source for illuminating a marking, and a photodiode or other appropriate device for detecting and reading the barcode.

In another embodiment, the infrared detector comprises an camera (infrared or at some other non-visible wavelength, as appropriate) which produces an image output. This image can then be processed using appropriate techniques to identify the value of the playing card(s), whether by deciphering a barcode or by interpreting any other form of marking. Alternatively, the image might be displayed in visible form to a human operator who then enters the card details into a computer as for conventional television coverage (this requires the infrared markings to be in a human-recognisable form).

There are various mechanism whereby the facility to identify the playing cards can be integrated into card game. For example, in one embodiment, the playing cards are dealt from a shoe, and the detector accesses the marking on a playing card as the card leaves the shoe. Alternatively, a playing card as it is dealt may be placed at a predetermined position on the playing table where it can be viewed by the detector. Usually the identification is most conveniently done when the cards are first dealt to the players, since at this time the cards are flat on the table and separated (or at least the most recently dealt card is should be unobscured when viewed from above).

In general it is desired to know not only the value of a card that has been dealt in a card game, but also the player who is in possession of the card. (For present purposes, the dealer or banker may also be regarded as a player, if appropriate; likewise shared or community cards, for example as dealt in certain variants of poker, may also be regarded in logical terms as belonging to a community player). In one embodiment, this player information is input by a human operator. In other words, the detector accesses the values of the cards involved in the game, and the human operator then specifies their allocation to the various players.

In another embodiment, the surface of the table may be marked to denote different player bays, for example, the table is divided by lines or other markings into different regions, and each region corresponds to a player bay. In this embodiment, the player who receives a particular card can be automatically identified based on the bay into which that card was dealt. One way of achieving this is to provide a dedicated detector for each bay. Another approach is to preconfigure the image output of an infrared camera so that it is known that a card identified in a particular region of the image corresponds to a particular bay on the table (assuming a fixed relationship between the camera and the table). This ownership can then be reflected in the visual information provided as part of the live broadcast. For example, for each player in the game, the visual information may reflect the cards currently held by that particular player.

The timing of the card identifications can also be configured as appropriate. In one embodiment, the identification of the card values may be subject to a request from a control system, which may in turn be triggered by a human operator (possibly the dealer indicating that a new card has been dealt). Alternatively, the detector may be operating continuously, and the computer system determines whenever a new card is identified (i.e. one that has not previously been identified for this card game).

In addition, the scope of the detector can be configured as appropriate. For example, a detector may be limited in scope to accessing markings for a single card at a predetermined location on the playing table. Alternatively, the detector may be a camera that images the entire table surface to identify the values (and locations) of any cards on the table. Another possibility is for the detector to scan multiple different positions on the table surface in sequence.

In one embodiment, the identifications of the cards are stored into a database or any other suitable form of storage. This stored information can then be used to support a whole range of applications, including enhanced commentary and debate, for example based on a statistical analysis of the card game, as well as the ability to review and analyse previous hands. The stored identifications can also be used to drive supplementary applications such as betting, ancillary mobile telephone games, and so on.

Another embodiment of the invention provides a set of playing cards in which the back surface of each playing card is provided with a marking indicating the value of the playing card. The markings are substantially invisible to the naked eye but accessible using a detector at infrared or other non-visible wavelengths to identify the value of a playing card. Such a set of playing cards can be used to form a standard set of fifty-two playing cards (plus joker(s) if appropriate), as used for poker, blackjack, bridge, and so on, and facilitate television coverage of such games, as described above.

The present approach therefore provides the capability to display on television the cards dealt to a player as they are dealt, potentially before they are even seen by a player. Multiple different games in a tournament can be monitored simultaneously by a single control system. This monitoring does not interfere with play, and indeed the players need not necessarily know whether or not the monitoring system is in operation. The data obtained from the playing cards can be used directly to drive television captions, graphics, and so on, interactive, mobile and web content on the progression of games and tournaments, as well as to drive forecasts, games, and betting content.

### BRIEF DESCRIPTION OF THE DRAWINGS

Various embodiments of the invention will now be described in detail by way of example only with reference to the following drawings:

FIG. 1 is a high-level schematic diagram of apparatus for televising a card game in accordance with one embodiment of the invention;

FIG. 2 is an example screen image as broadcast by the apparatus of FIG. 1 in accordance with one embodiment of the invention;

FIGS. 3A, 3B, and 3C are schematic diagrams of markings that may be applied to a playing card in accordance with one embodiment of the invention;

FIG. 4B represents a visible image of the back surface of a playing card and FIG. 4A represents an infrared image of the same surface, which includes an infrared marking, in accordance with one embodiment of the invention;

FIG. 5B represents a visible image of the back surface of another playing card and FIG. 5A represents an infrared image of the same surface, which includes an infrared marking, in accordance with one embodiment of the invention;

FIG. 6B represents a visible image of the back surface of another playing card and FIG. 6A represents an infrared image of the same surface, which includes an infrared marking, in accordance with one embodiment of the invention;

FIG. 7B represents a visible image of the back surface of another playing card and FIG. 7A represents an infrared image of the same surface, which includes an infrared marking, in accordance with one embodiment of the invention; and

FIG. 8 is a flowchart of a method of televising a card game in accordance with one embodiment of the invention.

### DETAILED DESCRIPTION

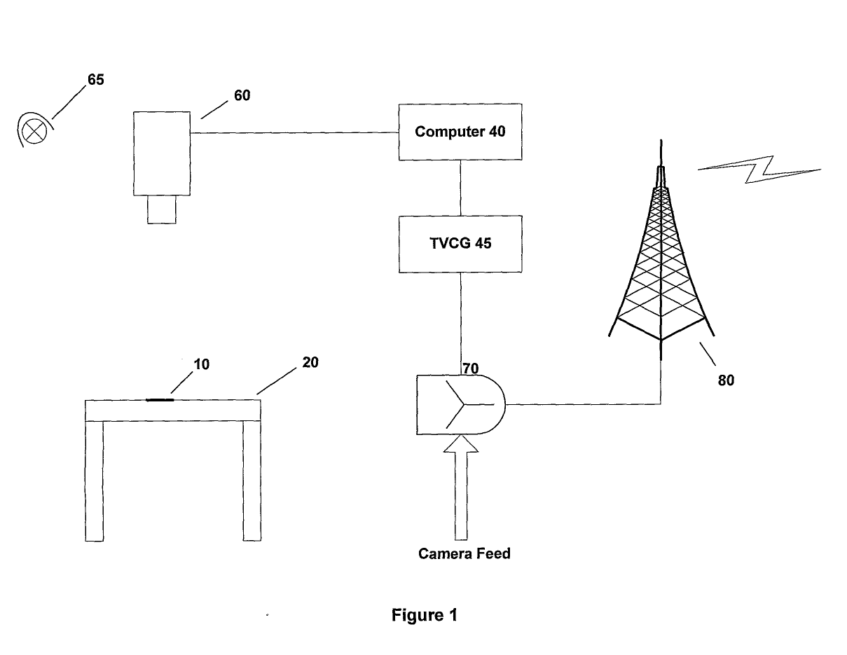

FIG. 1 illustrates in high-level form apparatus for televising a card game such as poker in accordance with one embodiment of the invention. As part of the card game, a playing card 10 is placed face-down onto a table surface 20. The playing cards used in casino games normally have a plastic laminate structure, typically based on PVC acetate or cellulose acetate, or a paper laminate structure, frequently with an exterior coating of PVC acetate or cellulose acetate. A typical dimension for playing card 10 is a height of 88 mm, and a width of about 60 mm (poker cards tend to be about 62 mm wide, but casinos often used narrower cards of about 57 mm width for easier handling).

The top surface of playing card 10 (i.e. the opposite surface to the face) incorporates an infrared marking that is described in more detail below. An infrared camera 60 is positioned looking down on playing card 10 (although camera or detector 60 may operate at other non-visible wavelengths if appropriate). In addition, a lamp 65 may also be provided to illuminate card 10, although in some embodiments lamp 65 may be omitted. Camera 60 and lamp 65 are discussed in more detail below.

The output of the camera 60 is passed to computer 40 (which may represent one or more separate computer systems). Computer 40 determines the identity (i.e. the suit and number) of playing card 10. This card identity is then stored for subsequent retrieval by editors, producers, and so on. In addition, the card identity is passed to a television graphics and character generator (TVCG) 45, which processes the data into pre-configured graphics layouts and templates to generate visual information indicative of the card identity. This visual information may be presented on-screen to a viewer of the televised card game in textual or graphical form. For example, a camera (not shown in FIG. 1) may generate a live image of the card game. This live image is then combined at mixer 70 with the visual information from TVCG 45 to produce the broadcast signal, which can then be transmitted to viewers from aerial 80. It will be appreciated that aerial 80 is schematic only, and may represent transmission over terrestrial, cable or satellite television services (analog or digital), as well as a web-cast over the Internet, some form of video downlink over a mobile or cellphone telephone network, or any other suitable form of distribution network. The television coverage of the card game may be provided simultaneously over multiple different networks. The television coverage may also be provided at a venue local to the card game itself, for example to assist spectators of the event.

The skilled person will be aware of many possible modifications to the embodiment shown in FIG. 1. For example, although FIG. 1 depicts the card game as being played on table 20, it will be appreciated that any suitable surface may be used. In addition, FIG. 1 shows only a single infrared camera 60. In an alternative embodiment, table 20 or other surface is provided with multiple infrared cameras 60, where each camera is associated with a particular slot or bay on table 20. Each player (including the dealer, if appropriate) is then seated or otherwise located at his or her own bay, and cards for a given player are placed onto the table at the corresponding bay for that player (which may be indicated by appropriate markings on the surface of table 20). The cameras are arranged so that they are directed towards cards placed in the associated bay. This then allows computer system 40 to allocate each card to the corresponding player by virtue of which camera 60 detected that particular card. For example, if there are four players denoted A, B, C, and D, and four corresponding cameras 60A, 60B, 60C, 60D, then any card detected by camera 60A is known to belong to player A.

In another embodiment, the system may be able to determine the identity of card 10, but not necessarily the player to whom the card has been dealt. In this embodiment, a human operator may provide this additional information to the computer system 40 (such as by using a keypad or other input mechanism, not shown in FIG. 1). It will be appreciated that this is a much easier task than having to enter individual card values (as in the prior art), in that firstly the number of players in the game is generally much less than the number of different cards (fifty-two in a conventional pack), and secondly the cards are usually dealt to the players in a predictable order (clockwise round the table). This latter property may allow the system to predict which player will receive the next card, and this can then be provided as the default option for the human operator to confirm or deny.

In another embodiment, rather than having camera 60 directed at the surface 30 of the table, the camera may instead be directed towards the shoe from which the playing cards are dealt. In this embodiment, as a card is removed from the show, it passes the camera, which detects the identity (value) of the card. The allocation of this card to a particular player can then be entered separately into computer system 40 by a human operator (as described above).

The timing of the identification of the playing cards can be controlled in various ways. In one embodiment, each card is specifically placed into or moved across the field of vision of camera 60 before being passed to the relevant player as part of the deal. When the new card is placed in front of the camera, the identity of this new card is determined. Another possibility is for the dealer to trigger the identification process, for example via a floor pedal, which activates camera 60 to make an identification. In another embodiment, the camera may identify the cards on the table surface 20 in a continuous manner, and flag whenever the arrival of a new card is determined (i.e. a new card is identified that has not previously been allocated to a player). Alternatively, if infrared camera 60 is directed at the card shoe, then it can be arranged to identify each new card as it is dealt from the shoe.

Although FIG. 1 shows a wired connection between the camera 60 and the computer system 40, it will be appreciated that this might be a wireless connection if appropriate, for example using a “wi-fi” local area network or similar. Likewise, the connections between the computer system 40, TVCG 45, mixer 70 and aerial 80 may of any suitable form, wired or wireless.

In addition, although FIG. 1 shows only a single table 20, it will be appreciated that computer system 40 may be linked to infrared cameras at multiple different tables 20. Furthermore, in other implementations, the functionality of mixer 70 and/or TVCG 45 may be performed in other systems, for example within computer system 40 itself, or within some other appropriate system.

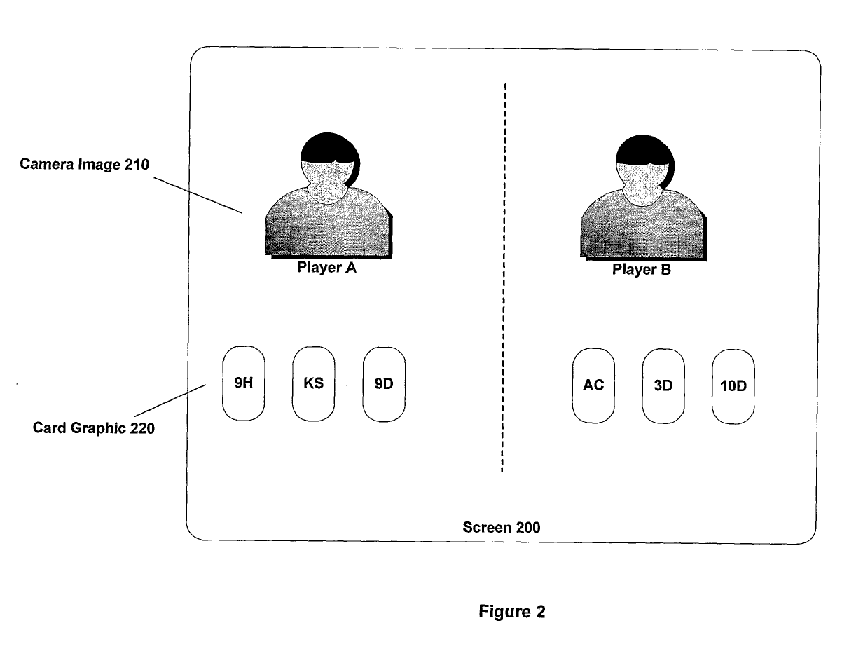

FIG. 2 represents a schematic illustration of the screen 200 broadcast by the apparatus of FIG. 1 in accordance with one embodiment of the invention (in other words, screen 200 represents what a viewer would see on their television set or other reception equipment). It is assumed that there are two players participating in the televised card game, denoted player A and player B in FIG. 2. A camera image 210 is shown of each player, which may be in the form of a single image of both players, or alternatively a separate camera image may be obtained for each player.

Beneath the camera image 210 of the players is a graphic region 220 that contains the visual information generated by TVCG 45. In the particular example shown, card graphic 220 provides a depiction of the three cards held by each player. The value of each card has been determined by using infrared camera 60. The card value is then shown in FIG. 2 by appropriate lettering (e.g. 9H represents the nine of hearts, while KS represents the king of spades). However, it will be appreciated that the card graphic 220 may instead represent some visual image or animation of the corresponding card itself, rather than simply a textual indication of the card value.

In some implementations, especially for digital television, the display of card graphic 220 may be optional, and under the control of the viewer. For example, in such implementations, the user can decide whether they want to be able to view all the hands (via graphic 220), or perhaps none of the hands (whereby graphic 220 is removed from the screen). Another possibility would be for a viewer to select to see only certain hands in graphic 220. For example, viewer might opt to see the cards for player A, but not for player B. This would then allow the viewer to experience the game from the perspective of player A, and hence to compare how the viewer would play a hand against the way that player A actually plays the hand.

The information about the identity of the cards in the game can be used for a wide range of purposes, apart from just displaying an on-screen image or representation of the relevant cards such as shown in FIG. 2. For example, data about card identities can be used to provide previews and forecasts as well as tournament statistics. Such additional facilities may be accessed via any suitable platform, for example a mobile telephone, a web client, a digital television set, and so on. The stored data in computer system 40 may also be used to support debate and analysis relating to previous games. Accordingly, it will be appreciated that the ability to provide rapid and reliable identification of cards as described herein can be used for entertainment, gaming or betting purposes, and helps to enhance production quality and/or to deliver additional revenue opportunities.

In order for infrared camera 60 to be able to identify playing card 10, playing card 10 is provided with an infrared marking on the top or back surface of the card (i.e. opposite to the face). This marking can be based either on emission or absorption of infrared light; the former is accomplished with infrared fluorescent dyes, while the latter is accomplished with infrared absorbing dyes. Note that it is generally important that the markings are not visible to the naked eye (i.e. in visible light), so that the players cannot determine which cards the other players have been dealt.

Infrared fluorescent dyes absorb light in the visible spectrum and re-emit the light energy in the infrared spectrum. As a result, such dyes can utilise existing ambient (visible) light energy. Accordingly, lamp 65 may be omitted from the embodiment of FIG. 1 if the ambient visible light level is sufficient for the infrared fluorescent dyes to produce an output that is bright enough in the infrared to allow camera 60 to read the relevant markings. Alternatively, lamp 65 may be retained to augment the visible light incident on the playing card 10, which in turn increases the output of the infrared fluorescence.

Because infrared fluorescent dyes absorb some light from the visible spectrum, they tend to be, to some extent, visible to the naked eye; in particular, they have the complementary colour to the light which they absorb. In practise, this effect tends to be small and the dyes appear quite covert.

There are relatively few infrared fluorescent dyes commercially available at present. In general, the absorption (“pump”) and emission wavelengths are quite close together. This makes detection more difficult, as relatively sharp optical filtering is required to remove the pump wavelength in order to permit detection of the emitted wavelength (otherwise the light used to trigger the fluorescence may swamp the emissions). In addition, the fluorescence may be non-linear, so that the florescent intensity does not scale linearly with the pump intensity. As a result, relatively high pump levels are required to excite sufficient fluorescence for good detection. A further concern is that the efficiency of fluorescent dyes tends to degrade with time (in other words they produce less fluorescent emission for a given pump intensity).

In view of the above circumstances, the embodiment of FIG. 1 has generally been developed and tested using infrared absorbing dyes, which are dyes that have little or no absorption in the visible spectrum, but absorb strongly in the infrared. Because such dyes do not make use of visible light (as do fluorescent dyes), they require illumination at infrared wavelengths. Thus in the context of the embodiment of FIG. 1, if playing card 10 is marked with an infrared absorbing dye, then lamp 65 is an infrared lamp to provide infrared illumination.

There is a wide range of commercially available infrared absorbing dyes. Factors involved in selecting a dye for use in the context of the present invention include the strength of absorption in the infrared, residual absorption in the visible, solubility of the dye in various organic solvents, and wavelength of the absorption peak. High absorption in the infrared leads to easily detected features (i.e. they will look “blacker” to the infrared camera). However, because the absorption of the dyes tends not to be very narrow in wavelength, there is normally an absorption tail that extends into the visible. Moving the absorption peak of the dye further into the infrared (i.e. towards longer wavelengths) therefore generally lowers the tail in the visible spectrum. On the other hand, the absorption peak does need to lie within the detection range of available cameras. Furthermore, because lamp 65 is used to supply infrared illumination, it is helpful if the peak absorption lies at a wavelength at which infrared LEDs are available. Taking into consideration the above criteria, the following two dyes were selected for testing: SDA6567 875 nm dye and SDA7780 901 nm dye, both supplied by H W Sands Corporation (see http://www.hwsands.com/) of Florida, USA.

Considering now the camera 60 from the embodiment of FIG. 1 in more detail, cameras based on silicon detectors (either CCD or CMOS) are, in principle, sensitive into the near infrared spectral region, up to approximately 1 μm wavelength. However, such cameras often incorporate an infrared blocking filter, which is normally essential in colour cameras to prevent infrared radiation from causing unwanted colour effects. Monochrome cameras also generally have such an infrared filter to allow correct grey-scale representations in visible light. The sensors in such cameras also vary in their infrared sensitivity to longer wavelengths.

In one particular implementation, the camera selected was the IDS uEyeUI-1220-M (from IDS Imaging Development Systems GmbH, of Obersulm, Germany, see http://www.ids-imaging.de/). This is a monochrome pVGA resolution (752×480 pixels) CMOS camera, with a USB2.0 interface. The camera has a global electronic shutter, which can be synchronised to external strobe illumination. The camera has excellent infrared response, which extends out to at least 900 nm. The camera incorporates an infrared blocking filter, which was replaced for the embodiment of FIG. 1 by a piece of anti-reflection coated glass of equal thickness (this allows the camera to focus to infinity properly). A narrow band infrared filter (70 nm bandwidth, centred at 880 nm) on the camera lens provides rejection of ambient visible light.

Infrared LEDs used for remote control purposes emit infrared radiation at 880 nm and are extremely cheap. They can be pulsed to high power (ten times their rated power) for short pulses (˜100 μs). In the embodiment of FIG. 1, lamp 65 comprises an illumination system built from 50 such LEDs, which is synchronised to the electronic shutter of the camera 60. The illumination system gains its power from the USB interface via the camera.

Although lamp 65 provides customised illumination, it will be appreciated that many conventional (i.e. visible) lights also produce a significant amount of infrared radiation, which may provide sufficient infrared illumination of playing card 10 to allow the infrared markings thereon to be detected. For example, the infrared illumination from standard television studio lighting may be sufficient for such purposes.

Various types of playing card 10 were studied using the imaging system of lamp 65 and camera 60. Those playing cards printed with red ink appear almost blank under the infrared illumination (i.e. little infrared absorption), and so allow easy detection of printed infrared absorption features. In contrast, playing cards printed with blue or dark colours are less suitable for use in the embodiment of FIG. 1, as these colours are visible to the imaging system (i.e. they tend to absorb infrared radiation) and hence tend to obscure any markings made with infrared absorbing ink.

The two selected dyes are soluble in a number of organic solvents, e.g. methanol, acetone, Methyl Ethyl Ketone (MEK), etc. As previously mentioned, most playing cards have a plastic coating, which is applied after the cards are printed. It was found that MEK temporarily softens the plastic surface. Consequently, dye carried in the solvent may be absorbed into the surface of the main layer of the card (rather than just remaining on the surface of the plastic coating), thereby making the dye markings resistant to damage by subsequent handling. Solutions of both dyes were prepared in concentrations from 0.1 mg/ml to a saturated solution of 30 mg/ml. In one implementation, the printing onto the playing cards was performed by an ink jet printer in which a printer cartridge had been emptied and refilled with the infrared dye.

Many infrared dyes are not stable under ultraviolet illumination and tend to bleach in such circumstances. This can lead to a deterioration in the visibility of printed infrared absorption features over a few days under normal lighting. In addition, infrared printing may be slightly visible under glancing illumination where the surface has been softened by the MEK or a similar solvent. To assist with both of these effects, a clear UV absorbing coating (Lyson Print Guard) was applied by aerosol over the playing card 10. This coating helps to disguise any surface effects, as well as providing filtering of any incident UV radiation to increase the longevity of the infrared markings.

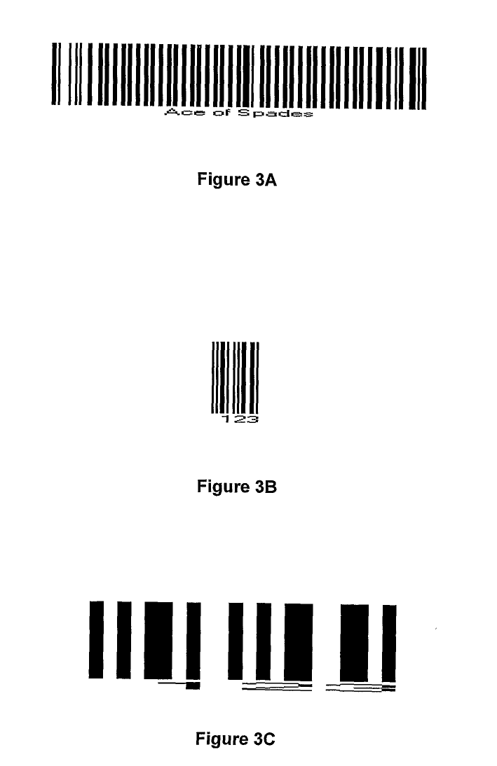

Two barcodes were generated for test printing. The first barcode, illustrated in FIG. 3A, is a Code 128 barcode that encodes the text “Ace of Spades”. This is a relatively high density code requiring small bar widths. Although this allows high density data storage, it also requires high realisation imaging for decoding. Since the embodiment of FIG. 1 generally only involves encoding 52 different states (corresponding to the number of different playing cards), a much simpler code can be used.

FIG. 3B illustrates a Code 2-5 interleaved barcode. To increase the bar width, thereby better matching the aspect ratio of playing card 10, this code was stretched horizontally, as shown in FIG. 3C. The stretched barcode as applied to a playing card of conventional size has a minimum feature width of 2.5 mm. Barcode scanners can typically decode with a resolution equivalent to just over 1 pixel per minimum feature, although in the embodiment of FIG. 1 it is prudent to provide higher resolution, since the image of the card may need to be manipulated (e.g. rotated, scaled etc.) before decoding. Assuming 2 pixels per minimum feature, camera 60 can cover an area of approximately 940 mm×600 mm.

The 875 nm dye SDA6567 was found to give higher contrast than the 90 nm dye SDA7780, and so further experiments concentrated on this first dye. A concentration of 25 mg/ml for the dye in the solvent was found to give good contrast, with lower concentrations producing lower contrast. On the other hand, with increased concentration above 25 mg/ml the dye started to become visible to the naked eye.

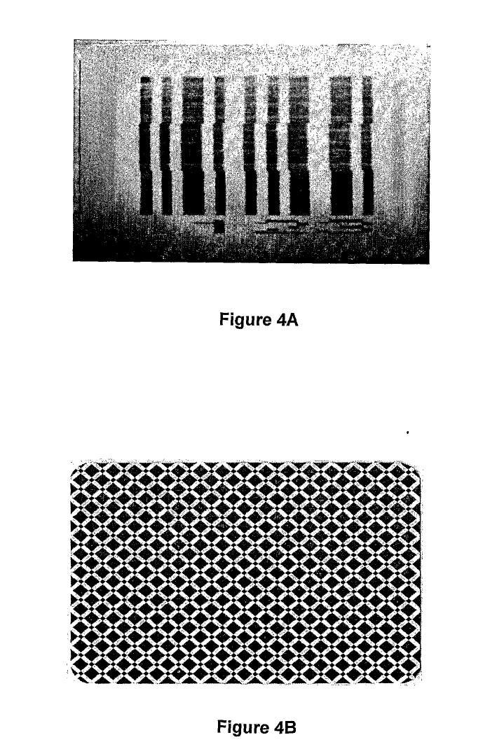

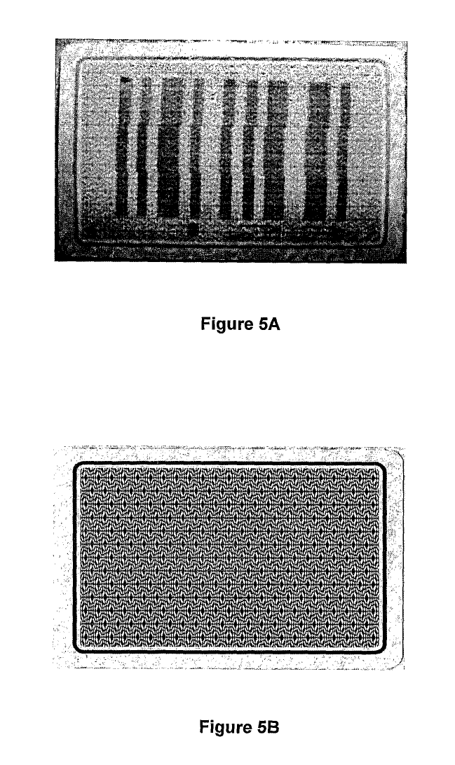

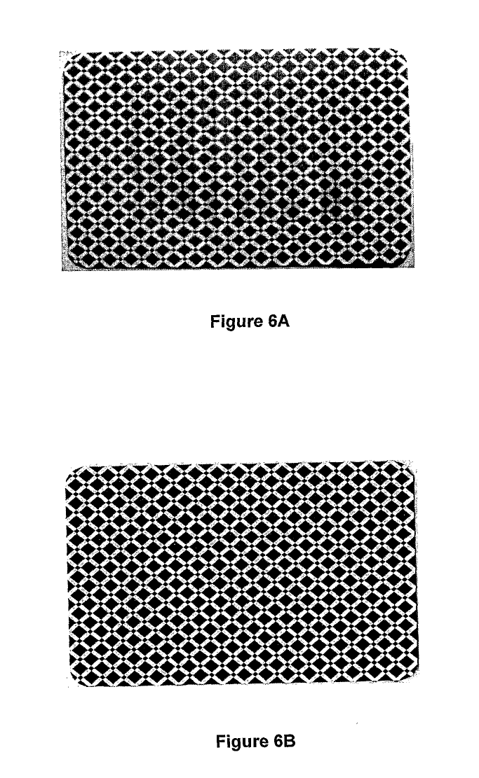

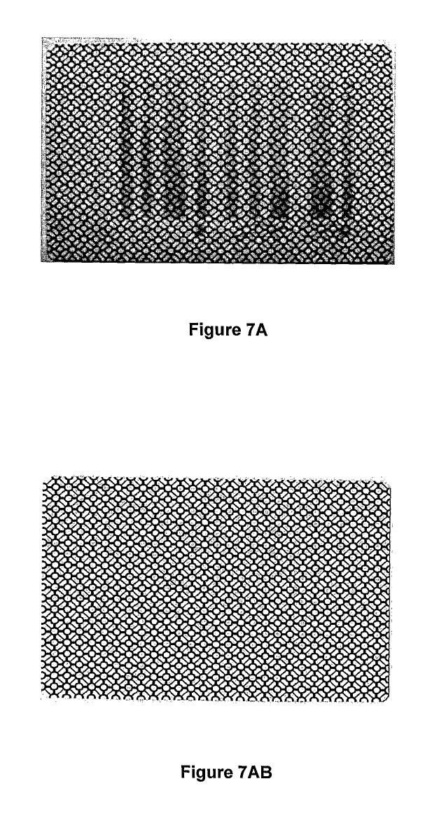

FIGS. 4-7 illustrate results obtained using the 875 nm dye SDA6567 at a concentration of 25 mg/ml for four different types of playing card. Thus FIGS. 4 and 5 involve red playing cards (i.e. cards with a red backing pattern), FIG. 6 involves a blue playing card, and FIG. 7 involves a black playing card. The IR images have been processed to increase contrast, but have had no further manipulation. Results are shown for cards coated with a UV absorption layer (the results for such cards did not differ significantly from the results for cards without such coating).

The discontinuity seen in the printed barcodes in FIGS. 4-7 is due to a lack of calibration for the printer (such calibration is difficult with infrared inks, as the calibration patterns cannot be directly observed). This artefact does not prevent reading of the barcodes, and can be resolved with further calibration work. The best results in terms of infrared visibility of the barcode were obtained with the red-printed cards (FIGS. 4 and 5). The playing card shown in FIG. 4 was particularly good, as the red ink used to print the backing of this card has very high reflectivity at 880 nm, and hence the visible pattern on the back of this card (see FIG. 4A) does not appear in the infrared image of FIG. 4B. The playing card of FIG. 5A was not quite as good as the card of FIG. 4A, in that some of the visible pattern (see FIG. 5B) is still apparent in the infrared image of FIG. 5A. Nevertheless, the bar code of FIG. 5A is still easily readable. On the other hand, the bar code of FIG. 6A, which is encoded onto the back of the blue playing card of FIG. 6B, is rather obscured, lacks contrast, and is difficult to read. Finally, the bar code of FIG. 7A, which is encoded onto the back of the black playing card of FIG. 7B, is intermediate in outcome. Note that in all cases the printed barcode is substantially invisible in visible light (i.e. as per FIGS. 4B, 5B, 6B, and 7B).

It will be appreciated that once camera 60 has obtained an image such as shown in FIGS. 4A, 5A, 6A and 7A, the image must be processed to access the bar code. The skilled person will be aware of various image processing algorithms that can be used for this purpose. Note that the exact image processing to be performed depends on the particular configuration of the system. Thus in some embodiments the orientation and location of the playing card may be known in advance, for example if newly dealt cards are always put onto table surface 20 in a predetermined position. In this case a section through the longitudinal centre of card image can be used to read the bar code. In other embodiments, the location and/or the orientation of the card image on table surface 20 may be uncertain e.g. the cards may be rotated at various angles on table surface 20. In this case the image processing algorithm first locates the cards (including their orientation), and then extracts the barcode. Further initial processing may be required if the cards are not necessarily flat on the table surface 20 (i.e. not necessarily perpendicular to the line of sight from camera 60).

In some embodiments, a visual camera may be provided in alignment with infrared camera 60. The visual camera may provide a better image for locating the positions and orientations of a card; once this has been done, the image from the infrared camera 60 can then be used to read the barcode for a card at a location and orientation as determined by the visual camera.

It will be appreciated that using a barcode on the back surface of the card to encode the value of a card permits a more robust identification of a card than image processing from the face of the card. In particular, barcodes have been especially designed for reliable machine processing, whereas the face sides of playing cards are often designed with regard to aesthetics and human interest. Accordingly, the embodiment shown in FIG. 1 provides a more dependable machine-based identification of cards than prior art television systems, which often rely upon a human operator to input card values from a camera image.

The embodiment of FIG. 1 is therefore based on using a camera 60 to obtain an image of the back surface of a playing card 10, with the resulting image then being processed to determine the barcode that identifies the playing card. In other embodiments however, rather than using a camera 60 to read the barcode, a barcode scanning system might be used instead. Such barcode scanning systems are well-known from supermarkets and other shops, and involve the barcode being scanned by a laser. The timing of the output from a point detector such as a photodiode is then used to determine the contents of the barcode being read (or the absence of any such barcode). Such a barcode scanning system can readily be applied to the embodiment of FIG. 1. In particular, lamp 65 then comprises a laser (optical or infrared, depending on the properties of the relevant dye used for marking the cards—e.g. whether fluorescent or absorbing), while camera 60 comprises a photodiode sensitive to infrared radiation.

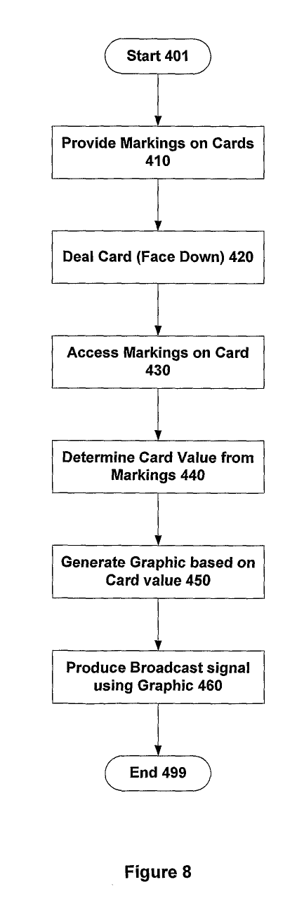

FIG. 8 provides a flowchart that shows the televising of a tournament card game in accordance with one embodiment of the invention. The method begins by marking the backs of the playing cards to allow the cards to be identified (410). The markings may directly specify the value of the card, or may represent some identifier, such a barcode, that can be mapped or converted to the card value. The markings may be made at the time of manufacture of the playing cards or may be applied subsequently.

The card game commences, and is assumed to involve the dealing or distribution of one or more cards (420). An infrared detector such as a camera or photodiode is now used to access the markings on the playing cards (430). As described above, the timing or trigger conditions for performing such an operation can be configured according to the details of the embodiment and the particular television coverage (for example, as each new card is dealt, the markings on the card may be read).

The data read from the playing cards is passed to computer system 40, which identifies the card value based on the data from the infrared detector (440) (unless this value is directly contained in the data itself). This may identification may involve (for example) processing an image from an infrared camera and/or performing some form of mapping or lookup based on a barcode value. The computer system 40 or TVCG 45 now generates a graphic based on the value of the card (450). This graphic may, for example, comprise text information, some form of image, some form of animation, or any combination of such elements as appropriate. The graphic is then incorporated into a broadcast signal (460) to provide viewers with an indication of the card that has just been dealt at operation 420. The digital information about the cards involved in the hand can also be used to drive programme analysis and comment, viewer input, betting, and so on.

Although the embodiments described above have primarily used infrared absorbing dyes to mark cards, other embodiments may use infrared fluorescent dyes instead. Note that infrared fluorescent dyes can give very good visibility since they are shifting energy from a shorter wavelength into a region that can be made spectrally quiet by suitable filtering of the ambient lighting. This can lead to a good signal to noise ratio, especially if the efficiency of such infrared fluorescent dyes improves in the future. In addition, although the embodiments described above have used barcodes for marking the playing cards, any other suitable form of markings might be used, such as lettering (e.g. 9S for 9 of spades). On the other hand, barcodes have the advantage of being robust in terms of identification, while at the same time difficult for humans to decipher (just in case there is any residual visibility of the marking on the backs of the playing cards in visible light). Furthermore, while the embodiments described above have used an infrared detector for accessing the markings on the playing cards, a detector at some other (non-visible) wavelength might be used instead, for example to detect ultraviolet radiation. Note that in this case, the markings could again be provided via emission (UV fluorescence) or absorption, and any illumination by lamp 65 would be at an appropriate wavelength (e.g. UV for UV absorbing ink).

In conclusion therefore, although a range of embodiments of the invention has been described above by way of example, the skilled person will be aware of further possible variations and modifications. In addition, the various features described herein may be utilised in combinations other than those specifically set out above. Accordingly, the presented embodiments are not intended to be limiting, but rather the invention is defined by the appended claims and their equivalents.

1-37. (canceled)

38. A method of televising a card game, wherein each playing card in the card game has a value, said method including:
providing the back surface of each playing card with a marking that is substantially invisible to the naked eye, said marking indicating the value of the playing card;
using a detector of non-visible radiation to access said marking to identify the value of a playing card involved in said card game;
generating visual information indicative of the identified value of the playing card, wherein said visual information is included in a broadcast of the card game.

39. The method of claim 38, wherein said detector is an infrared detector.

40. The method of claim 39, wherein the marking is made with an infrared absorbing dye.

41. The method of claim 40, wherein the absorption peak of the infrared absorbing dye is in the range 840-920 nm.

42. The method of claim 41, wherein the absorption peak of the infrared absorbing dye is in the range 875-905 nm.

43. The method of claim 39, wherein the marking is made with an infrared fluorescent dye.

44. The method of claim 38, wherein the marking is made with a dye that has penetrated a plastic coating of the playing card.

45. The method of claim 38, wherein the back surface of the playing card appears red in visible light.

46. The method of claim 38, wherein said marking comprises a barcode that encodes the value of the playing card.

47. The method of claim 46, wherein said detector comprises a bar code scanner.

48. The method of claim 38, wherein said detector comprises a camera.

49. The method of claim 49, further comprising illuminating the back surface of the playing card to allow the detector to access said marking, wherein said illumination comprises infrared radiation.

50. The method of claim 38, wherein the playing cards are dealt from a shoe, and the detector accesses the marking on a playing card as the card leaves the shoe.

51. The method of claim 38, wherein the card game is played on a table, and the detector accesses the marking on a playing card as it is laid on the table.

52. The method of claim 51, wherein the surface of the table is marked to denote the different player bays, and wherein the generated visual information indicates that said playing card is associated with a particular player based on the bay in which the playing card was placed.

53. A set of playing cards, wherein the back surface of each playing card is provided with a marking indicating the value of the playing card, said marking being substantially invisible to the naked eye but accessible using a detector of non-visible radiation to identify the value of a playing card.

54. The playing cards of claim 53, wherein said marking is accessible using an infrared detector.

55. The playing cards of claim 53, wherein the marking is made with a dye that has penetrated a plastic coating of the playing cards.

56. The playing cards of claim 55, wherein said marking is applied to the card using a solvent that temporarily softens the plastic coating of the playing cards.

57. The playing cards of claim 53, wherein each playing card is covered with a coating to provide protection for the marking against ultraviolet radiation.
